(19) United States
(12) Patent Application Publication
(10) Pub. No.: US 2004/0036474 A1
(43) Pub. Date: Feb. 26, 2004

(54) Device for orienting drill cores

(76) Inventor: Gerard Clerc, rue Gambetta (FR)

Correspondence Address: YOUNG & THOMPSON, 745 SOUTH 23RD STREET 2ND FLOOR, ARLINGTON, VA, 22202

(21) Appl. No.: 10/432,900

(22) PCT Filed: Nov. 12, 2001
(86) PCT No.: PCT/FR01/03514

(30) Foreign Application Priority Data
Dec. 4, 2000 (FR) 00/15648

(51) Int. Cl. G06F 19/00; G01V 3/08

(52) U.S. Cl. 324/377; 702/1

(57) ABSTRACT

Devices for orienting a drill core (1) sampled in a rocky environment subjected, during its formation, to earth's magnetic field. The device comprises a bed (2), a cradle (3), elements (4) for associating the cradle with the bed, elements (7) for driving the drill core in rotation, elements (8) for measuring the magnetic field prevailing in one measurement point (10), these latter elements consisting of a polar part (100) comprising an air gap (101) matching the shape of the lateral wall (102) of the drill core (1) which is driven in a rotational movement in the air gap (101) and at least a magnetic coil (13) enclosing the polar part, and elements (11) for processing the measurement signal delivered by the magnetic coil. The invention is useful for orienting drill cores sampled in oil-bearing terrain.

The present invention relates to an improvement to devices for orienting drill cores of circularly cylindrical shape about an axis of revolution, after said cores have been extracted from a rocky or analogous medium which was subjected, while it was being formed, to a terrestrial magnetic field and which, as a result, possesses natural remanent magnetization, and the invention relates more particularly to devices enabling cores to be oriented that have been taken from oil-bearing rocks, like the apparatus described in international application WO 00/63688.

It is known, particularly in the context of oil prospecting, that the earth's subsoil needs to be analyzed. For this purpose, wells or boreholes are drilled and pieces of rock referred to as “cores” are taken from the subsoil by means of special tools known as “coring” tools, which cores are then analyzed.

By analyzing such cores, it is possible to discover the composition of the subsoil. However, in certain cases, and in particular when working oil, it is necessary to know the exact orientation that the cores had while they were in the ground, before being extracted.

Unfortunately, such cores are cut out of the subsoil by means of coring tools which are driven in rotation so it is not possible, on extraction, to know the original orientation of a core. It is then necessary to proceed with an operation referred to in the art as “orienting” the core.

That said, it is necessary firstly to recall that on the earth, there is a magnetic field directed towards a point referred to as “north” which presently has a position that is well determined relative to the terrestrial globe.

However it is also necessary to be aware that over past geological eras, the position of magnetic north has not always been the same relative to the continents since the continents have drifted over the surface of the terrestrial globe. It is also known that the direction of the magnetic field has reversed a large number of times. All of those changes are well known and they are thoroughly cataloged. It is also known that terrestrial rocks posses magnetization comprising two components, one component representing the magnetization induced by the present magnetic field, which is referred to in the art as the “induced magnetization”, and the other representing the so-called “remanent” magnetization that corresponds to the magnetization that was induced by the earth's magnetic field as it existed at the time the rocks were being formed, with the rocks thus memorizing the axis and the direction of that field.

Given firstly the axis and the direction of said remanent magnetization in a core, and secondly the epoch of formation of the rock layer from which the core has been extracted and the position of said rock layer in the ground, it is possible to determine the orientation of the core relative to said rock and thus relative to the terrestrial globe.

International patent application WO 00/63688 describes a device enabling such drill cores to be oriented, both on site and in the laboratory.

That device comprises an oblong bench, a cradle, means for associating the cradle with the bench, means for rotating the core substantially about its axis of revolution relative to the cradle while the cradle is situated on a first portion of the bench in such a manner that the side wall of the core passes substantially through a “measurement point”, means for measuring the magnetic field that exists at said measurement point, said measurement means being suitable for delivering a “measurement signal”, and means for processing the measurement signal.

An object of the present invention is to simplify the structure of the device of that international application, by proposing means for measuring the magnetic field that exists at the measurement point that are very simple in shape, easy to make, and nevertheless highly sensitive.

More precisely, the present invention provides an improvement to the device for orienting a core of substantially circularly cylindrical shape about an axis of revolution and taken from a rocky or analogous medium that was subjected, while it was being formed, to a terrestrial magnetic field, and which as a result possesses natural remanent magnetization, the device comprising: a bench, a cradle, means for associating the cradle with the bench, means for rotating the core substantially about its axis of revolution relative to the cradle while said cradle is situated in a first portion of the bench in such a manner that its side wall passes substantially through a “measurement point”, means for measuring the magnetic field that exists at said measurement point, said measurement means being suitable for delivering a “measurement signal”, and means for processing the measurement signal, the improvement being characterized by the fact that the means for measuring the magnetic field that exists at said measurement point are constituted by a pole piece having an air gap of shape substantially complementary to the side wall of said core, said pole piece being associated with said cradle in such a manner that said core is caused to rotate about its axis of revolution in said air gap, and at least one magnetic coil surrounding said pole piece, said magnetic coil being suitable for delivering said measurement signal at its output.

Other characteristics and advantages of the invention appear from the following description given with reference to the accompanying illustrative but non-limiting drawing, in which:

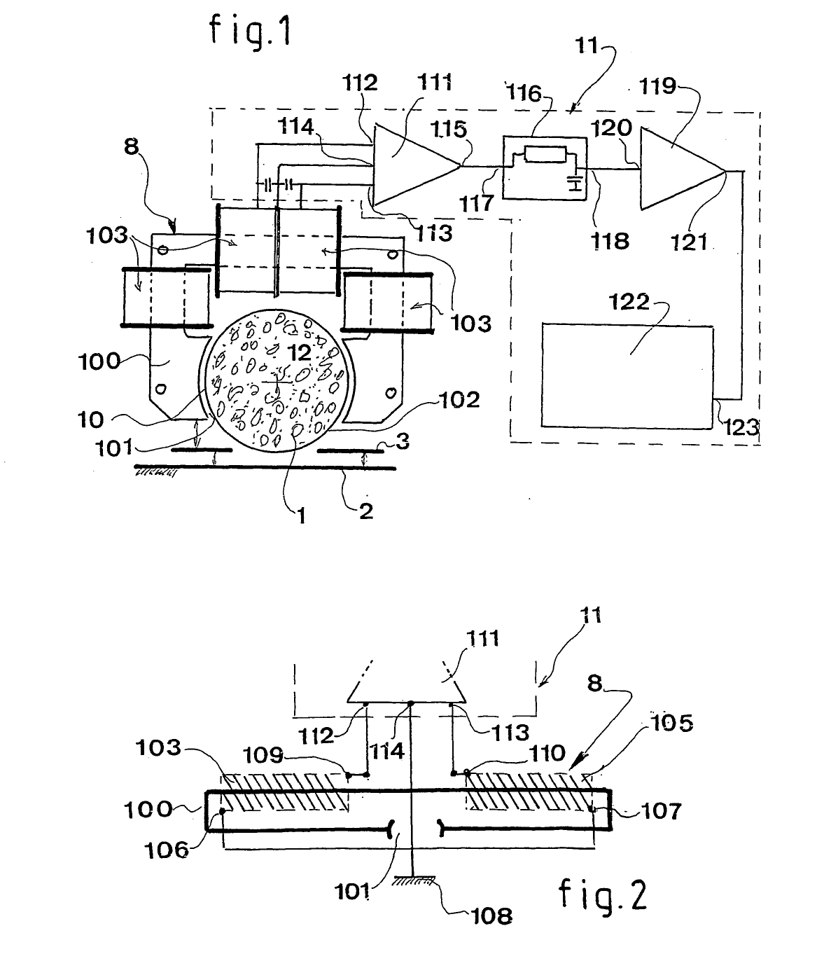

FIGS. 1 and 2 are two theoretical diagrams showing the principle on which the improvement of the invention is based as applicable to a device for orienting drill cores.

The Applicant seeks to make it clear that FIGS. 1 and 2 are merely diagrams of one embodiment of the invention and that other embodiments can exist in compliance with the definition of the invention.

The Applicant also specifies that when the invention is defined as having “at least one” element having a given function, the embodiment described may have a plurality of said elements.

The Applicant also states that if the embodiment of the invention as shown has a plurality of elements of identical function and if in the description it is not specified that the invention must necessarily have some particular number of said elements, then the invention may be defined as having “at least one” of said elements.

The Applicant also specifies that the prior art for the device of the invention for orienting cores of substantially circularly cylindrical shape about an axis of revolution is constituted by international application WO 00/63688, and in particular by the description of that International application and the drawings accompanying it.

That said, the present invention relates to an improvement to the device for orienting a core 1 of substantially circularly cylindrical shape about an axis of revolution 12 taken from a rocky or analogous medium that was subjected to a terrestrial magnetic field while it was being formed and that therefore has natural remanent magnetization, the device comprising: a bench 2, a cradle 3, means 4 for associating the cradle with the bench, means 7 for rotating the core substantially about its axis of revolution relative to the cradle while the cradle is situated in a first portion of the bench, and in such a manner as to cause its side wall to pass substantially through a “measurement point” 10, means 8 for measuring the magnetic field that exists at the measurement point, said measurement means being suitable for delivering a “measurement signal”, and means 11 for processing the measurement signal.

According to an essential characteristic of the improvement of the invention, the means 8 for measuring the magnetic field that exists at the measurement point 10 are constituted by a pole piece 100 having an air gap 101 of a shape that is substantially complementary to the shape of the side wall 102 of the core 1, said pole piece 100 being associated with the cradle 3 in such a manner that the core is caused to rotate about its own axis of revolution 12 in the air gap 101, together with at least one magnetic coil 103 surrounding the pole piece 100, said magnetic coil 103 being suitable for outputting the measurement signal.

As explained in the above-referenced document, the core possesses natural remanent magnetization, with a component that is oriented perpendicularly to its axis 12. As a result, it behaves like a north-south magnetic bar pivoting about an axis perpendicular to the north-south direction, said axis being constituted specifically by the axis 12 of the core. As a result, while the core is rotating in uniform manner about its axis 12, the magnetic flux passing through the coil 103 under guidance from the pole piece 100 varies periodically. These flux variations thus generate an alternating current in the coil making it possible to orient the core 1, as described in international application WO 00/63688.

In a highly advantageous embodiment, the improved device has at least two magnetic coils 103, 105 surrounding the pole piece 100, the two ends 106, 107 of the two magnetic coils that are furthest apart from each other on the magnetic path defined by the pole piece 100 being connected to a terminal 108 that is maintained at a reference potential, e.g. ground, while the other two ends 109 and 110 of the two magnetic coils constitute the outputs of the means for measuring the magnetic field that exists at the measurement point 10 and suitable for delivering the measurement signal.

In addition, and advantageously, in an attempt to reduce magnetic and electrical interference of all kinds, the means 11 for processing the measurement signal comprise a direct current (DC) differential amplifier 111 having three inputs 112, 113, and 114, including a reference input 114, and one output 115, the reference input 114 being connected to the terminal 108, and the other two inputs 112 and 113 being connected respectively to the other two ends 109 and 110 of the two coils 103 and 105.

In highly advantageous manner, the means 11 for processing the measurement signal further comprise a lowpass filter 116, e.g. with a frequency of 0.72 hertz (Hz), having an input 117 and an output 118, the input 117 of the lowpass filter being connected to the output 115 of the differential amplifier 111.

The means 11 for processing the measurement signal then further advantageously comprise a lowpass amplifier 119, e.g. operating in the frequency range 0 to 10 Hz, having an input 120 and an output 121, the input 120 of the lowpass amplifier being connected to the output 118 of the lowpass filter 116, and generally an element 122 for providing at least temporary storage, such as an oscilloscope or a printer or the like, having an input 123 connected to the output 121 of the lowpass amplifier 119.

Naturally, in a preferred embodiment, the pole piece 100, in the form of a slightly closed-in U-shape, is constituted by a stack of laminations, e.g. made of mu-metal, which laminations are advantageously insulated from one another, e.g. by means of layers of varnish.

1/ An improvement to the device for orienting a core (1) of substantially circularly cylindrical shape about an axis of revolution (12) and taken from a rocky or analogous medium that was subjected, while it was being formed, to a terrestrial magnetic field, and which as a result possesses natural remanent magnetization, the device comprising: a bench (2), a cradle (3), means (4) for associating the cradle with the bench, means (7) for rotating the core substantially about its axis of revolution relative to the cradle while said cradle is situated in a first portion of the bench in such a manner that its side wall passes substantially through a “measurement point” (10), means (8) for measuring the magnetic field that exists at said measurement point, said measurement means being suitable for delivering a “measurement signal”, and means (11) for processing the measurement signal, the improvement being characterized by the fact that the means (8) for measuring the magnetic field that exists at said measurement point (10) are constituted by a pole piece (100) having an air gap (101) of shape substantially complementary to the side wall (102) of said core (1), said pole piece being associated with said cradle (3) in such a manner that said core is caused to rotate about its axis of revolution (12) in said air gap (101), and at least one magnetic coil (103) surrounding said pole piece, said magnetic coil (103) being suitable for delivering said measurement signal at its output.

2/ An improvement according to claim 1, characterized by the fact that it has at least two magnetic coils (103, 105) surrounding said pole piece (100), the two ends (106, 107) of the two magnetic coils that are furthest apart from each other on the magnetic path defined by the pole piece (100) being connected to a terminal (108) that is maintained at a reference potential, the other two ends (109, 110) of the two magnetic coils constituting the outputs of the means for measuring the magnetic field that exists at said measurement point being suitable for delivering said measurement signal.

3/ An improvement according to claim 2, characterized by the fact that the means (11) for processing the measurement signal comprise a DC differential amplifier (111) having three inputs (112, 113, 114), including a reference input (114), and an output (115), said reference input (114) being connected to said terminal (108), the other two inputs (112, 113) being connected respectively to the other two ends (109, 110) of the two coils (103, 105).

4/ An improvement according to claim 3, characterized by the fact that the means (11) for processing the measurement signal further comprise a lowpass filter (116) having an input (117) and an output (118), said input (117) of said lowpass filter (116) being connected to the output (115) of said differential amplifier (111).

5/ An improvement according to claim 4, characterized by the fact that the means (11) for processing the measurement signal further comprise a lowpass amplifier (119) having an input (120) and an output (121), said input (120) of said lowpass amplifier (119) being connected to the output (118) of said lowpass filter (116).

6/ An improvement according to claim 5, characterized by the fact that the means (11) for processing the measurement signal further comprise an at least temporary storage element (122) having an input (123) connected to the output (121) of said lowpass amplifier (119).

7/ An improvement according to any one of claims 1 to 6, characterized by the fact that said pole piece (100) is constituted by a stack of laminations.

8/ An improvement according to claim 7, characterized by the fact that said pole piece (100) is constituted by a stack of mu-metal laminations.
